(19) United States
(12) Patent Application Publication
(10) Pub. No.: US 2025/0331076 A1
(43) Pub. Date: Oct. 23, 2025

(54) Copper contact jaw and method for production thereof

(71) Applicant: SMS group GmbH, Mönchengladbach (DE)

(72) Inventor: Michael VILLIS, Castrop-Rauxel (DE)

(73) Assignee: SMS group GmbH, Mönchengladbach (DE)

(21) Appl. No.: 18/864,509

(22) PCT Filed: Mar. 22, 2023
(86) PCT No.: PCT/EP2023/057304

§ 371 Date: Nov. 8, 2024

(30) Foreign Application Priority Data
May 11, 2022 (DE) 10 2022 204 610.2

(51) Int. Cl. H05B 7/103

(52) U.S. Cl. CPC H05B 7/103

(57) ABSTRACT

A copper contact jaw for an electrical smelting unit can be attached to an electrode carrying arm of the smelting unit. By the contact jaw an electrode of the smelting unit can be electrically conductively connected to the electrode carrying arm. The copper contact jaw has a main body having a rear face and an oppositely arranged front face, a first end face and a second, axially oppositely arranged end face, and at least one first and one second side face; two contact faces arranged on the front face of the main body, which contact faces are designed to be mirror-symmetrical relative to one another and extend axially along the main body; and a cooling channel system having a coolant inlet opening and a coolant outlet opening and a plurality of cooling channels that extend axially and radially through the main body.

### CROSS-REFERENCE TO RELATED APPLICATION

This application is a national stage application, filed under 35 U.S.C. § 371, of International Patent Application PCT/EP2023/057304, filed on Mar. 22, 2023, which claims the benefit of German Patent Application DE 10 2022 204 610.2, filed on May 11, 2022.

### BACKGROUND

The present application relates to a copper contact jaw for an electric smelting unit, in particular an electric arc furnace, which can be attached to an electrode carrying arm of the smelting unit and via which an electrode of the smelting unit can be electrically conductively connected to the electrode carrying arm, and to a method for producing a copper contact jaw.

Contact jaws of this type have long been known from the prior art, for example, from German published patent application DE 34 43 574 A1 and from German published patent application DE 10 2004 005 051 A1.

The production of such contact jaws consisting of pure copper is effected in such a manner that a rolled or forged copper blank is initially provided and then mechanically machined by introducing bores for water cooling. Due to the size of a contact jaw, which can have a length of 750 mm, a width of 600 mm and a thickness of 150 mm, for example, deep-hole drilling is still a technical challenge. For this reason, large drill diameters of at least 24 mm are currently used, wherein the bores are typically drilled into the contact jaw from the respective end faces opposite to one another, such that the bores meet in the middle. The two openings can then be closed by welding with a copper plug or by means of threaded locking screws.

When welding copper, the material to be welded usually has to be preheated evenly to a temperature of approximately 600° C., which is intensive in terms of energy and time. At the points to be welded, temperatures of more than 1200° C. are then generated, which lead to local recrystallization of the microstructure and thus to a loss of the original hardness that the material obtained during the forging or rolling process. Moreover, sealing with threaded locking screws or similar means also cannot be permanently ensured due to the high ambient temperatures within the unit.

### SUMMARY

The present disclosure is based on the object of providing a copper contact jaw for an electric smelting unit, in particular for an electric arc furnace, which is improved over the prior art, and a method for producing such a copper contact jaw that is improved over the prior art. The object is achieved by a copper contact jaw with the as disclosed herein and by a method as disclosed herein.

The copper contact jaw, which can be attached to an electrode carrying arm of the smelting unit and via which an electrode of the smelting unit can be electrically conductively connected to the electrode carrying arm comprises a main body having a rear face, which is usually turned towards an electrode arm, and an oppositely arranged front face, which is usually turned awards an electrode, a first end face and a second, axially oppositely arranged end face, which in the installed state is then turned towards the melt in the smelting unit, and at least one first and one second side face; two contact faces arranged on the front face of the main body, which are designed to be mirror-symmetrical relative to one another and extend axially along the main body; and a cooling channel system having a coolant inlet opening and a coolant outlet opening and a plurality of cooling channels that extend axially and radially through the main body.

In the same manner, the method for producing a copper contact jaw provides that initially a forged or rolled copper contact jaw blank is provided, which comprises a main body having a rear face and an oppositely arranged front face, a first end face and a second, axially oppositely arranged end face, at least one first and one second side face, and two contact faces arranged on the front face of the main body, which are designed to be mirror-symmetrical relative to one another and extend axially along the main body; wherein subsequently a coolant inlet opening, a coolant outlet opening and a plurality of cooling channels running axially and radially through the main body are introduced mechanically, preferably by means of deep-hole drilling.

Due to the cooling channel system, which comprises a coolant inlet opening, a coolant outlet opening, and a plurality of cooling channels that run axially and radially through the main body, improved heat dissipation is achieved on the one hand, due to the increased number of cooling channels. Furthermore, the cooling channels can be placed closer to the highly stressed contact faces due to their much smaller diameter compared to the prior art, as a result of which the cooling effect of these can be significantly improved. In terms of manufacturing technology, the copper contact jaw no longer needs to be welded. On the one hand, this ensures that the material does not undergo recrystallization and thus retains the microstructure set during the forging or rolling process, as a result of which a longer service life is ensured. On the other hand, there is no need for a second machining operation, including set-up time, as a result of which manufacturing costs are reduced in addition.

Further advantageous embodiments are indicated in the dependent formulated claims. The features listed individually in the dependent formulated claims can be combined with one another in a technologically useful manner and can define further embodiments of the invention. In addition, the features indicated in the claims are further specified and explained in the description, wherein further preferred embodiments of the invention are shown.

Within the meaning of the present disclosure, the term “plurality of cooling channels” is understood to mean that the cooling system comprises at least ten, preferably at least twenty, more preferably at least thirty, even more preferably at least forty, and most preferably at least fifty individual cooling channels.

Advantageously, the plurality of cooling channels are formed in the main body and fluidically connected to one another in such a manner that they can be supplied with a coolant via a single central coolant inlet opening and a single central coolant outlet opening.

In accordance with the method for producing a copper contact jaw, the 1 to 3 large bores of at least 24 mm are replaced by a plurality of small deep-hole bores that are fluidically connected to one another. Due to the plurality of cooling channels, the required cooling water volume of 5000 l/h, for example, can be ensured. Furthermore, the plurality of cooling channels, which are formed by a deep-hole bore that is open on one side, allows them to be positioned in the copper contact jaw in such a manner that the threaded locking screws for closing the openings are not directly exposed to the radiant heat of a melt when the copper contact jaw is in use.

It is preferably provided that each of the cooling channels has a diameter in the range from 4.0 to 16.0 mm, more preferably a diameter in the range from 5.0 to 14.0 mm, even more preferably a diameter in the range from 6.0 to 12.0 mm, and most preferably a diameter in the range from 6.00 to 10.0 mm. In a particularly preferred embodiment, the diameter of each deep-hole bore and thus of each cooling channel is 8.0 mm.

In a further advantageous embodiment, it is provided that the plurality of cooling channels are formed from a plurality of cooling channel groups, each of which extends axially or radially through the main body of the copper contact jaw. In this connection, it is particularly preferably provided that each of the plurality of cooling channel groups comprises at least two, preferably at least three, more preferably at least four or more cooling channels. In a particularly preferred embodiment, each of the plurality of cooling channel groups comprises four cooling channels. Due to the combining of the plurality of cooling channels into individual groups, the manufacturing process can be further simplified, since multiple deep-hole bores can be created in a single work step.

In a further aspect, the present application also relates to an electric smelting unit, in particular an electric arc furnace, comprising an electrode carrying arm and a copper contact jaw arranged on the electrode arm.

### BRIEF DESCRIPTION OF THE DRAWINGS

The invention and the technical environment are explained in more detail below with reference to the figures. It should be noted that the invention is not intended to be limited by the exemplary embodiments shown. In particular, unless explicitly shown otherwise, it is also possible to extract partial aspects of the facts explained in the figures and combine them with other components and findings from the present description and/or figures. In particular, it should be noted that the figures and in particular the size relationships shown are only schematic. Identical reference signs designate identical objects, such that explanations from other figures can be used as a supplement if applicable.

FIG. 1a and FIG. 1b show an embodiment of the copper contact jaw in a perspective representation.

FIGS. 2 to 6 show different sectional views of the copper contact jaw shown in FIG. 1a and FIG. 1b.

FIG. 7 shows an embodiment of an electrode arm comprising the copper contact jaw.

### DETAILED DESCRIPTION

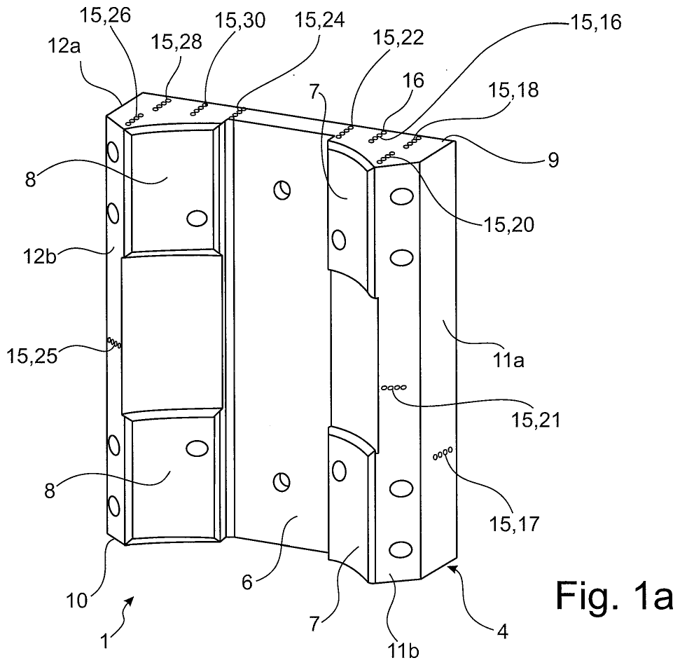

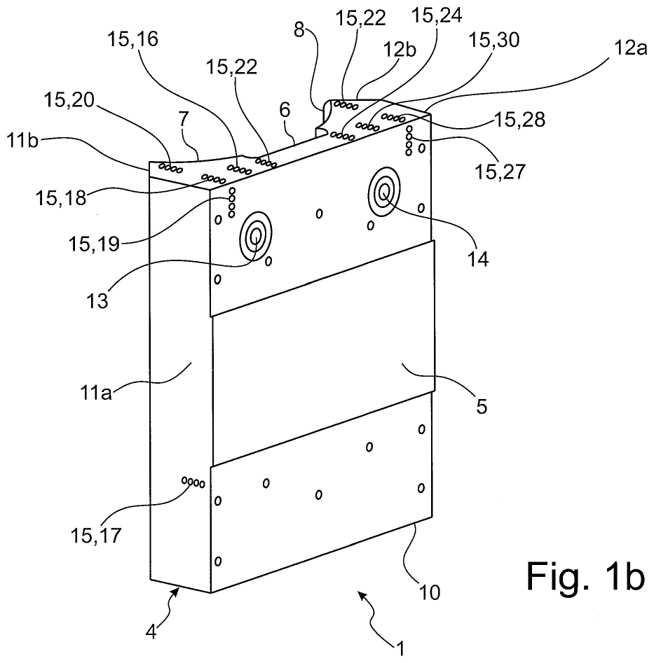

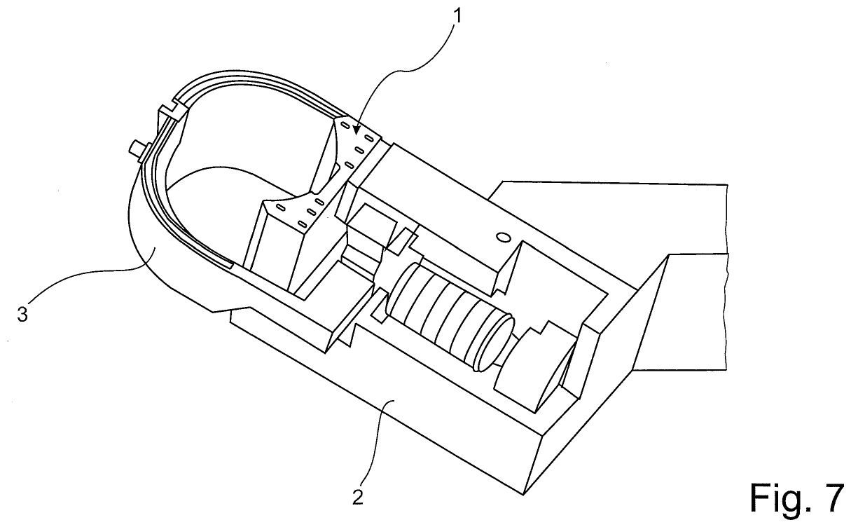

FIGS. 1a and 1b show an embodiment of a copper contact jaw 1 in accordance with the invention in two different perspective representations. The present copper contact jaw 1 is made of pure forged copper (99.98% by weight) and is intended for use in an electric smelting unit, such as, for example, an electric arc furnace. Such a smelting unit/the electric arc furnace can comprise one or more electrode carrying arms 2 (see FIG. 7), to the distal end of which in each case the copper contact jaw 1 is fastened. An electrode of the smelting unit, such as, for example, a graphite electrode, is electrically conductively connected to the electrode carrying arm 2 by means of the copper contact jaw 1 and a fastening means 3. Here, the electrode (not shown) is usually friction-lock connected to the electrode carrying arm 2 by the fastening means 3.

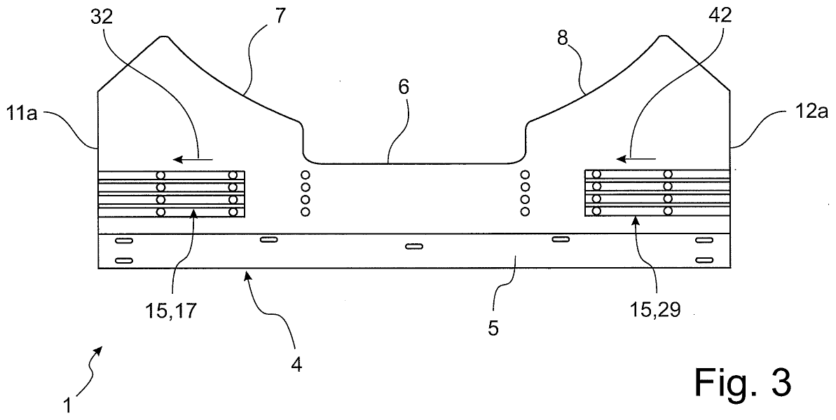

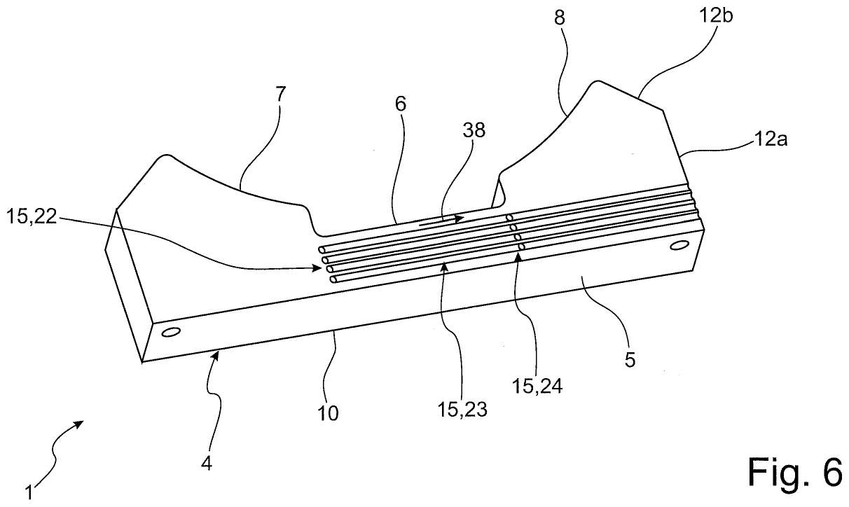

As shown based on FIGS. 1 to 6, the copper contact jaw 1 comprises a main body 4 having a rear face 5 turned towards an electrode arm 2 and a front face 6 arranged opposite the rear face 5 and then turned towards the electrode. In order to achieve a sufficiently high electrical contact between the electrode and the copper contact jaw 1, the front face 6 has two contact faces 7, 8, in each case comprising a concave curvature, which extend axially along the main body 4 and are designed to be mirror-symmetrical relative to one another. It should be noted that the front face 6 can also be formed by a continuous concave surface design as an alternative to the embodiment shown in the present case. In this case, the two contact faces 7, 8 form an integral component of this.

Furthermore, the main body 4 comprises a first end face 9, a second end face 10 arranged axially opposite the first end face 9 and then turned towards the melt in the installed state, and two side faces 11a, 11b, 12a, 12b in each case.

In accordance with the invention, it is provided that the copper contact jaw 1 comprises a cooling channel system having a coolant inlet opening 13, a coolant outlet opening 14 and a plurality of cooling channels 15, which extend through the main body 4 in an axial and radial direction.

In the present embodiment, the coolant inlet opening 13 and the coolant outlet opening 14 are arranged in an upper third, as viewed in the axial direction, and thus in a region turned towards the first end face 9, such that they are not directly exposed to the radiant heat of the melt when in use. As can also be seen based on the representations, the copper contact jaw 1 in each case has a single and thus central coolant inlet opening/coolant outlet opening 13, 14, which are fluidically connected to the plurality of cooling channels 15.

In the embodiment shown, the plurality of cooling channels 15 are formed from a plurality of individual cooling channel groups 16 to 30, which in each case run axially 16, 18, 20, 22, 24, 26, 28, 30 or radially 17, 19, 21, 23, 25, 27, 29 through the main body 4 and are thus arranged alternately in each case relative to one another. In the present case, each of the cooling channel groups 16 to 30 consists of four individual cooling channels 15, wherein each of these individual cooling channels 15 is formed by a separate deep-hole bore that has been drilled through a corresponding face 5, 9, 11a, 11b, 12a, 12b in the main body 4. In other words, each of the cooling channels 15 is formed by a deep-hole bore that is open on one side and is subsequently closed by threaded locking screws (not shown).

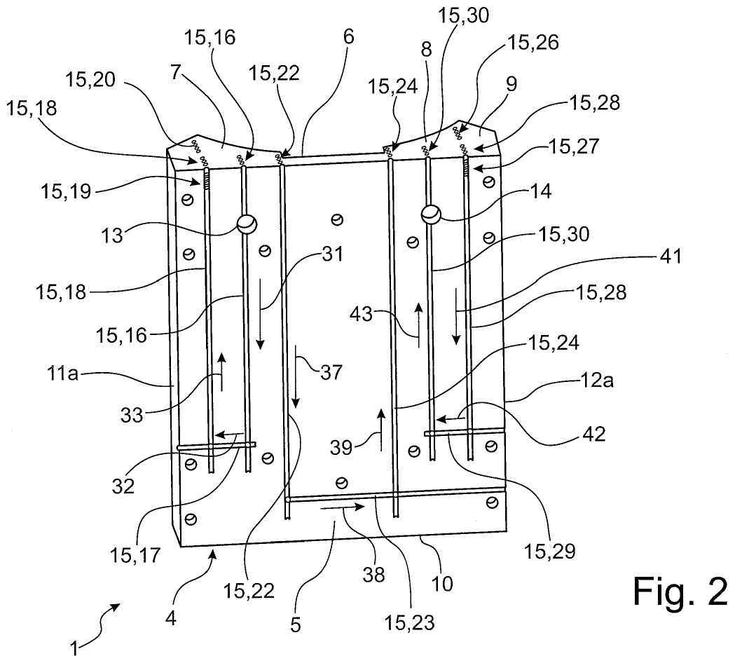

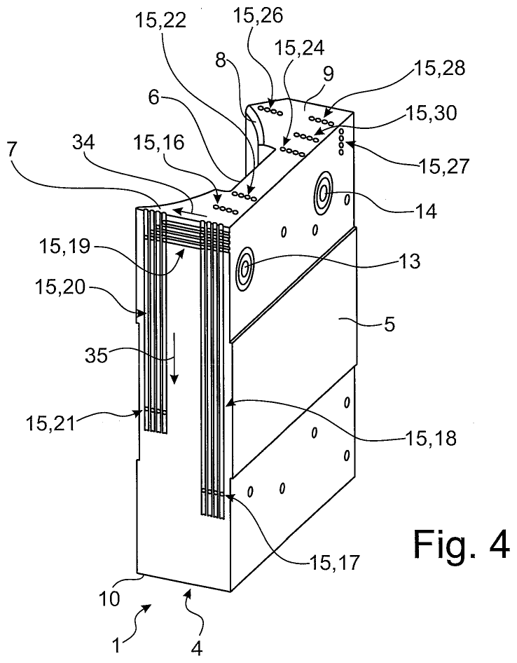

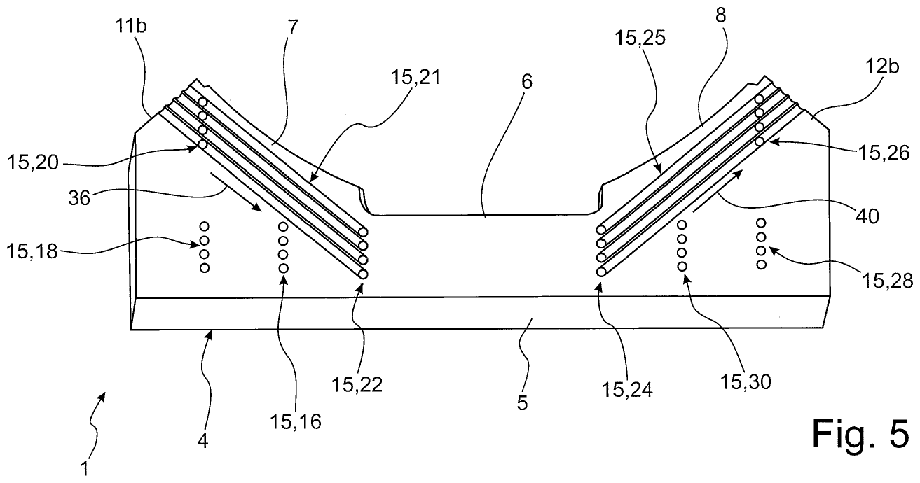

A coolant, for example water, introduced via the central coolant inlet opening 13 therefore initially flows via the four individual channels 15 of the first group 16 in the direction of the second end face 10 (see arrow 31 in FIG. 2). The coolant is then fed via the four channels 15 of the second group 17 to the cooling channels 15 of the third group 18 (see arrow 32 in FIG. 2), via which it flows through the copper contact jaw 1 in the direction of the first end face 9 (see arrow 33 in FIG. 2). Subsequently, the coolant passes via the four channels 15 of the fourth group 19 to the channels 15 of the fifth group 20, via which it flows through the copper contact jaw 1 again in the direction of the second end face 10 (see arrows 34, 35 in FIG. 4). As can also be seen based on FIGS. 4 and 5, the coolant then flows via the four channels 15 of the sixth group 21, which are arranged centrally in the axial direction and run in the radial direction, into the cooling channels 15 of the seventh group 22, via which it flows through the copper contact jaw 1 in the direction of the second end face 9 (see arrow 36 in FIG. 5 and arrow 37 in FIG. 2). Via the adjoining four channels 15 of the eighth group 23, the coolant then flows from the left-hand copper contact jaw half shown in FIG. 2 into the right-hand copper contact jaw half opposite in the radial direction (see arrow 38 in FIG. 2), in which it flows through the individual groups 24 to 30 in the opposite direction to the left-hand copper contact jaw half, as shown based on arrows 39 to 43 in FIGS. 2, 3 and 5.

In the present embodiment, the copper contact jaw 1 has an axial length of 750 mm, a width of 600 mm and a thickness of 150 mm. The individual cooling channels 15 were created using a deep-hole drill with a diameter of 8.0 mm, such that a minimum volume flow of 5000 L/h can be realized over the entire cooling channel system.

As can be seen in particular based on the representations in the two FIGS. 1a/1b, all deep-hole bores are spaced as far as possible from the second end face 10, which is turned towards the melt when in use, such that the threaded locking screws, by means of which the individual openings of the deep-hole bores are closed, are not directly exposed to the radiant heat of the melt.

### REFERENCE SIGNS

1 Copper contact jaw
2 Electrode carrying arm
3 Fastening means
4 Main body
5 Rear face
6 Front face
7 Contact face
8 Contact face
9 First end face
10 Second end face
11a Side face
11b Side face
12a Side face
12b Side face
13 Coolant inlet opening
14 Coolant outlet opening
15 Cooling channels
16 Axial cooling channel group
17 Radial cooling channel group
18 Axial cooling channel group
19 Radial cooling channel group
20 Axial cooling channel group
21 Radial cooling channel group
22 Axial cooling channel group
23 Radial cooling channel group
24 Axial cooling channel group
25 Radial cooling channel group
26 Axial cooling channel group
27 Radial cooling channel group
28 Axial cooling channel group
29 Radial cooling channel group
30 Axial cooling channel group
31 Arrow
32 Arrow
33 Arrow
34 Arrow
35 Arrow
36 Arrow
37 Arrow
38 Arrow
39 Arrow
40 Arrow
41 Arrow
42 Arrow
43 Arrow

1.-9. (canceled)

10. A copper contact jaw (1) for an electrical smelting unit, the copper contact jaw (1) being configured to be attached to an electrode carrying arm (2) of the electrical smelting unit and to electrically conductively connect an electrode of the electrical smelting unit to the electrode carrying arm (2), the copper contact jaw (1) comprising:
a main body (4) having
a rear face (5) and a front face (6) arranged opposite the rear face (5),
a first end face (9) and a second, axially oppositely arranged end face (10), and
at least one first and one second side face (11a, 12a);
two contact faces (7, 8) arranged on the front face (6) of the main body (4), the two contact faces (7, 8) being mirror-symmetrical relative to one another and extending axially along the main body (4); and
a cooling channel system having
a coolant inlet opening (13),
a coolant outlet opening (14), and
a plurality of at least ten cooling channels (15) that extend axially and radially through the main body (4).

11. The copper contact jaw (1) according to claim 10,
wherein each of the cooling channels (15) has a diameter in a range from 4.0 to 16.0 mm.

12. The copper contact jaw (1) according to claim 10,
wherein each of the cooling channels (15) has a diameter in a range from 5.0 to 14.0 mm.

13. The copper contact jaw (1) according to claim 10,
wherein each of the cooling channels (15) has a diameter in a range from 6.0 to 12.0 mm.

14. The copper contact jaw (1) according to claim 10,
wherein each of the cooling channels (15) is formed by a deep-hole bore opened on one side.

15. The copper contact jaw (1) according to claim 10,
wherein the plurality of cooling channels (15) is formed from a plurality of cooling channel groups (16, 17, 18, 19, 20, 21, 22, 23, 24, 25, 26, 27, 28, 29, 30), which in each case run axially or radially through the main body (4) of the copper contact jaw (1).

16. The copper contact jaw (1) according to claim 15,
wherein each of the plurality of cooling channel groups (16, 17, 18, 19, 20, 21, 22, 23, 24, 25, 26, 27, 28, 29, 30) comprises at least two cooling channels (15).

17. The copper contact jaw (1) according to claim 15,
wherein each of the plurality of cooling channel groups (16, 17, 18, 19, 20, 21, 22, 23, 24, 25, 26, 27, 28, 29, 30) comprises at least three cooling channels (15).

18. The copper contact jaw (1) according to claim 15, wherein each of the cooling channels (15) of each cooling channel group (16, 17, 18, 19, 20, 21, 22, 23, 24, 25, 26, 27, 28, 29, 30) is formed by a deep-hole bore.

19. The copper contact jaw (1) according to claim 10,
wherein the coolant inlet opening (13) and the coolant outlet opening (14) are arranged in the rear face (5) and at an end turned towards the first end face (9).

20. An electric smelting unit, comprising
an electrode carrying arm (2), and
the copper contact jaw (1) according to claim 10 arranged on the electrode carrying arm (2).

21. A method for producing a copper contact jaw (1), comprising:
providing a forged or rolled copper contact jaw blank, which has
a main body (4) having
a rear face (5) and
a front face (6) arranged opposite the rear face (5),
a first end face (9) and a second, axially oppositely arranged, end face (10),
at least one first and one second side face (11a, 12a), and
two contact faces (7, 8) arranged on the front face (6) of the main body (4), which are mirror-symmetrical relative to one another and extend axially along the main body (4); and
deep-hole drilling a coolant inlet opening (13), a coolant outlet opening (14) and a plurality of cooling channels (15) extending axially and radially through the main body (4).
